(19) United States
(12) Patent Application Publication
(10) Pub. No.: US 2025/0110028 A1
(43) Pub. Date: Apr. 3, 2025

(54) SPECIMEN EMBEDDING

(71) Applicant: Emit Imaging, Inc., South Boston, MA (US)

(72) Inventors: Steven Toddes, Cockeysville, MD (US); Janeen L. Vanhooke, Forest Hill, MD (US)

(21) Appl. No.: 18/895,999

(22) Filed: Sep. 25, 2024

Related U.S. Application Data
(60) Provisional application No. 63/586,739, filed on Sep. 29, 2023.

(51) Int. Cl. G01N 1/36

(52) U.S. Cl. CPC G01N 1/36

(57) ABSTRACT

Embedding compositions with light-attenuating properties for preparing specimens for sectioning and imaging are disclosed. An embedding composition may be a colloidal suspension including a continuous phase such as optimal cutting temperature compound (OCT), paraffin, or epoxy, etc., and a dispersed phase such as carbon powder, red blood cells, or barium sulfate, etc. The dispersed phase may reduce the transmission and/or scattering of light within the embedding composition, resulting in reduction or elimination of artifacts such as edge brightening, glow, and/or blurring. In some cases, the light-attenuation properties of an embedding composition may be adjusted to approximate or match those of the specimen.

### CROSS-REFERENCE TO RELATED APPLICATIONS

This application claims priority to U.S. Provisional Application No. 63/586,739, filed Sep. 29, 2023, entitled “SPECIMEN EMBEDDING,” the entire contents of which are incorporated herein by references for all purposes.

### BACKGROUND

The present disclosure generally relates to compositions for embedding specimens for examination, and more specifically to compositions for embedding specimens for sectioning using, for example, a sectioning apparatus such as a microtome, cryomicrotome, vibratome, macrotome, etc.

Sectioning is the process of removing slices of a material to facilitate examination of a specimen. Embedding a specimen in a rigid or semi-rigid embedding medium may stabilize the specimen for sectioning. The embedding composition may be in liquid form when combined with the specimen. The specimen and embedding composition may be allowed or caused to harden into a block prior to sectioning.

### SUMMARY

Aspects of the present disclosure relate to compositions for embedding specimens for sectioning and imaging. Moreover, aspects of the present disclosure involve embedding compositions having light-attenuating properties to reduce artifacts caused by the transmission and/or scattering of light in an embedding compound. In at least some embodiments, the light-attenuating properties may be achieved by suspending particles in an embedding compound.

A first aspect of the present disclosure relates to a composition comprising an embedding compound and a light-attenuating material.

In some embodiments of the first aspect, the composition is a colloidal suspension of the light-attenuating material in the embedding compound.

In some embodiments of the first aspect, the embedding compound includes optimal cutting temperature compound (OCT).

In some embodiments of the first aspect, the light-attenuating material includes C45 carbon particles.

In some embodiments of the first aspect, the composition comprises 0.05-0.50% C45 carbon particles by weight.

In some embodiments of the first aspect, the light-attenuating material includes India ink.

In some embodiments of the first aspect, the light-attenuating material includes 0.001% to 1.0% India ink by volume.

In some embodiments of the first aspect, the light-attenuating material includes 0.005% to 0.100% India ink by volume.

In some embodiments of the first aspect, a light-attenuating property of the composition matches that of a specimen to be embedded.

In some embodiments of the first aspect, the embedding compound includes one or more of OCT, paraffin, water-based glycol, epoxy, acrylic, agar, gelatin, celloidin, tris-buffered saline (TBS), Cryogen, or resin.

In some embodiments of the first aspect, the light-attenuating material includes one or more of C45 carbon particles, India ink, carbonates, talcum powder, barium sulfate, or dried red blood cells.

In some embodiments of the first aspect, the composition may further include a dispersing agent.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The foregoing and other objects, features, aspects, and advantages of the embodiments disclosed herein will become more apparent from the following detailed description when taken in conjunction with the following accompanying drawings.

FIG. 1 shows a picture of two embedding compositions formulated using optimal cutting temperature compound (OCT) and different concentrations of C45 carbon particles, according to embodiments of the present disclosure;

FIG. 2A illustrates an experimental setup of a mouse in an embedding composition that includes C45 carbon particles, according to embodiments of the present disclosure;

FIG. 2B shows an image obtained of the mouse in the embedding composition with C45 carbon particles, according to embodiments of the present disclosure;

FIG. 3 is an image showing autofluorescence of a porcine heart embedded in an embedding composition 2 that includes C45 carbon particles, according to embodiments of the present disclosure;

FIG. 4 shows a picture of four embedding compositions formulated using optimal cutting temperature compound (OCT) and different concentrations of India ink, according to embodiments of the present disclosure;

FIG. 5A shows an experimental setup for testing various embedding compositions and fiducials, according to embodiments of the present disclosure;

FIG. 5B shows an image obtained using the experimental setup of FIG. 5A, according to embodiments of the present disclosure;

FIGS. 6A and 6B illustrate pixel intensities for a row of OCT-based fiducials in the image shown in FIG. 5B, according to embodiments of the present disclosure;

FIGS. 7A and 7B illustrate pixel intensities for a row of tissue-based fiducials in the image shown in FIG. 5B, according to embodiments of the present disclosure;

FIG. 8 illustrates a comparison of pixel intensities in the image shown in FIG. 5B between OCT-based fiducials and tissue-based fiducials having equal concentrations of fluorophore, according to embodiments of the present disclosure;

FIG. 9 shows an image of autofluorescence exhibited by the experimental setup shown in FIG. 5A, according to embodiments of the present disclosure;

FIG. 10A is a conceptual drawing showing a first experimental setup used for characterizing light-attenuating embedding compositions comprising OCT and India ink using OCT-based fiducials, according to embodiments of the present disclosure;

FIG. 10B shows an image obtained using the first experimental setup shown in FIG. 10A, according to embodiments of the present disclosure;

FIG. 11A is a conceptual drawing showing a second experimental setup used for characterizing light-attenuating embedding compositions comprising OCT and India ink using OCT-based fiducials, according to embodiments of the present disclosure;

FIG. 11B shows an image obtained using the second experimental setup shown in FIG. 11A, according to embodiments of the present disclosure;

FIG. 12 shows a graph illustrating pixel intensities obtained from the images shown in FIGS. 10B and 11B, according to embodiments of the present disclosure;

FIG. 13A is a conceptual drawing showing an experimental setup used for characterizing tissue-based fiducials, according to embodiments of the present disclosure;

FIG. 13B shows an image obtained using the experimental setup shown in FIG. 13A, according to embodiments of the present disclosure;

FIG. 14 shows a graph illustrating integrated pixel intensities obtained from the image shown in FIG. 13B, according to embodiments of the present disclosure;

FIG. 15 shows a graph of integrated pixel intensities from the image shown in FIG. 9 showing autofluorescence in the experimental setup shown in FIG. 5B, according to embodiments of the present disclosure;

FIG. 16A is a conceptual drawing showing the experimental setup used for characterizing tissue-based fiducials, according to embodiments of the present disclosure;

FIG. 16B shows an image 1605 generated based on autofluorescence in the experimental setup shown in FIG. 16A, according to embodiments of the present disclosure; and

FIG. 17 shows a graph of integrated pixel intensities from the image shown in FIG. 16B, according to embodiments of the present disclosure.

The above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the intended application and use environment.

### DETAILED DESCRIPTION

Histology is the study of biological specimens using magnification or other means of enhancement. Specimens may include cells, tissue, organs, and/or larger structures up to and including whole animals. Sectioning is the process of slicing the specimen to produce thin slices (“sections”), which can be used to examined certain portions of the specimen and, in some cases, to reconstruct a three-dimensional image or model of the specimen. A specimen may be prepared for sectioning by various methods of fixation and embedding. Fixation may refer to preserving the specimen such that its structure is maintained during sectioning and examination. Embedding may involve immersing or otherwise placing the specimen in an embedding medium that provides structural support around the specimen to facilitate sectioning. Additional preparation of specimens may include introducing dyes and/or stains including fluorophores.

As the material is sectioned, each section may be examined using a microscope and/or camera. A technique called block-face imaging involves examination of the block face of the specimen that remains after a section is removed. Examination may include “white light” imaging (e.g., conventional microscopy/photography) to examine specimen structure. Use of certain dyes may aid in identifying different types of cells and/or other materials in the specimen. Fluorescence imaging may be used alone or in combination with white light imaging to detect certain biological molecules (e.g., DNA, RNA, and proteins) and/or to visualize biological processes.

Traditionally, researchers and clinicians have embedded specimens in clear (e.g., transparent or light translucent) media. The inventors have recognized, however, that embedding specimens in a clear medium may lead to distortions when obtaining images under certain conditions. For example, reflected light and/or fluorescent emission from a specimen may appear to be greater near an edge of the specimen; that is, close to the embedding media. Furthermore, areas of the embedding medium close to, but outside of, the specimen may appear to reflect and/or emit light. These effects may hinder imaging by obscuring boundaries, distorting geometry, exaggerating or understating fluorophore activity in different regions of the specimen, and, in extreme cases, saturating detectors of the imaging system. The phenomenon is particularly apparent when performing block-face imaging, in which images are generated from light reflected and/or fluoresced by the specimen as opposed to passing through an isolated section from a back light. While block-face imaging can achieve high signal-to-noise ratio (SNR), light may be received from a greater depth of material (e.g., both the specimen and the embedding medium), which may exacerbate some of these effects.

The inventors hypothesize that some of these effects may be caused by scattering and/or diffusion of light within the embedding medium. The scattered and/or diffused light from the embedding medium may result in additional light (e.g., from a white light source and/or fluorescent excitation illumination source) delivered to the edges of the specimen relative to the face. Thus, reflected light and/or fluorescence may appear greater near the edges of the specimen. The inventors further hypothesize that the embedding medium may scatter and/or diffuse light emitted (e.g., scattered and/or fluoresced) by the specimen. Thus, some light emitted by the specimen may appear to have originated outside of the specimen, thereby obscuring the specimen's boundaries and/or distorting the specimen's geometry.

Offered herein are techniques for reducing or eliminating the boundary effects that occur when performing histology in a clear embedding medium. In some implementations, an embedding composition may be formulated to approximate or match certain optical characteristics of the specimen. For example, an embedding medium may be doped, treated, and/or combined with another material to cause attenuation of light traversing the embedding composition. As a result, scattering and/or diffusion of light occurring in the embedding composition may more closely approximate that of the specimen, thereby reducing the amount of additional light reaching the edge of a specimen relative to its face. These techniques may be especially beneficial when imaging excised tissues (e.g., where there is no other tissue or other biological material between the excised tissue and the embedding medium) and/or when imaging outer portions of a specimen (e.g., skin).

An embedding composition may be a suspension (such as a colloidal suspension) of particles or other material (e.g., a dispersed phase) suspended in a medium (e.g., a continuous phase). The dispersed phase may be suspended substantially uniformly throughout the continuous phase. In some implementations, the dispersed phase may include particles, inclusions, etc., having a size on the order of 100-5,000 nm. In some implementations, the dispersed phase material may be larger or smaller. In some implementations, the dispersed phase may be chosen to exhibit certain light absorbing and/or reflectance properties. In some implementations, the dispersed phase may have light attenuation properties (e.g., broad-spectrum light attenuation properties). In various implementations, the dispersed phase may include, for example and without limitation, carbon and/or other carbonates, talcum powder, barium sulfate, dried red blood cells and/or other tissue particles, pigments, etc. The dispersed phase may be suspended substantially uniformly throughout the continuous phase.

In some implementations, the continuous phase material may be chosen based on the imaging modality (e.g., white light, fluorescence, electron, etc.) and/or the temperature of the specimen during imaging. For example, the continuous phase may be chosen such that the embedding composition is liquid at room temperature and solid (or highly viscous) when cooled for sectioning in a sectioning apparatus such as a microtome, cryomicrotome, vibratome, and/or macrotome, etc. In another example, the continuous phase may be liquid at elevated temperatures and solid (or highly viscous) at room temperature. In yet another example, the continuous phase may be a liquid that may be activated, cured, or otherwise chemically and/or physically altered to solidify or thicken for sectioning and/or imaging. In various implementations, the continuous phase may include, for example and without limitation, optimal cutting temperature compound (OCT), paraffin, water-based glycol, epoxy, acrylic, agar, gelatin, celloidin, tris-buffered saline (TBS), Cryogen, resin, etc.

Because different specimens and types of specimens exhibit different optical properties, embedding compositions may be formulated accordingly. An embedding composition exhibiting lower light attenuation than the specimen may result in the distortions described above, while a composition exhibiting higher light attenuation may result in different distortions such as an apparent darkening of portions of a specimen near its edge due to receiving less light scattered from the embedding composition than middle portions of the specimen receive from the surrounding tissue. Thus, an embedding composition may be formulated to have light-attenuating characteristics that approximate those of a certain type of tissue. For example, in some cases, kidney tissue may exhibit higher attenuation than brain tissue. Accordingly, a “lighter” composition may be formulated to image brain tissue.

### Example 1. Preparation of a Light-Attenuating Embedding Composition Comprising OCT and Carbon Particles

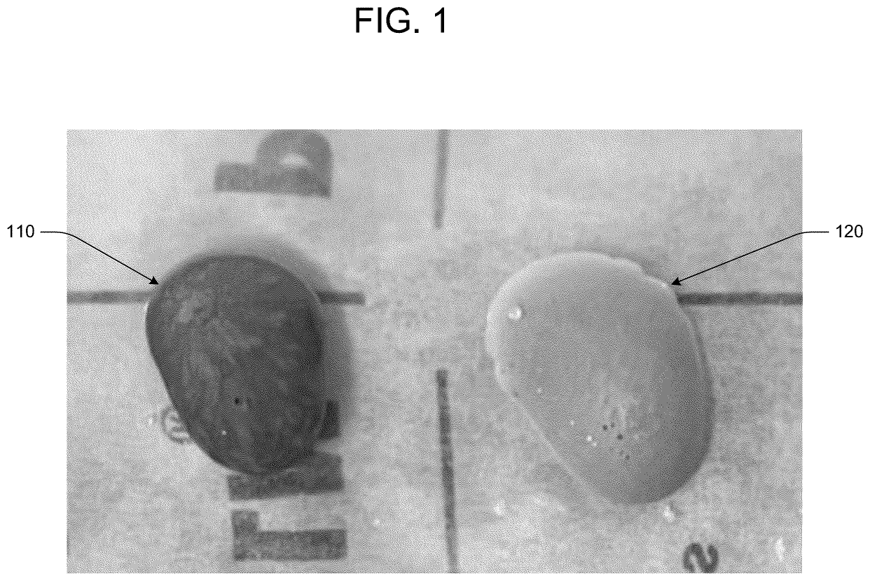

FIG. 1 shows blocks 110 and 120 of OCT compositions prepared with different concentrations of carbon particles. The OCT is a blend of glycols and resins formulated for cryostat sectioning at and below −10° C., marketed as Scigen Tissue-Plus by Fisher Scientific of Hampton, NH. The first block 110 is a first composition of OCT prepared with 0.3% carbon particles by weight. The second block 120 is a second composition of OCT prepared with 0.06% carbon particles by weight. In some implementations, the carbon particles may have a size between 100 nm and 5,000 nm. In some implementations, the carbon particles may have a size between 100 nm and 3,000 nm. In some cases, the size of carbon particles used may span a range of sizes.

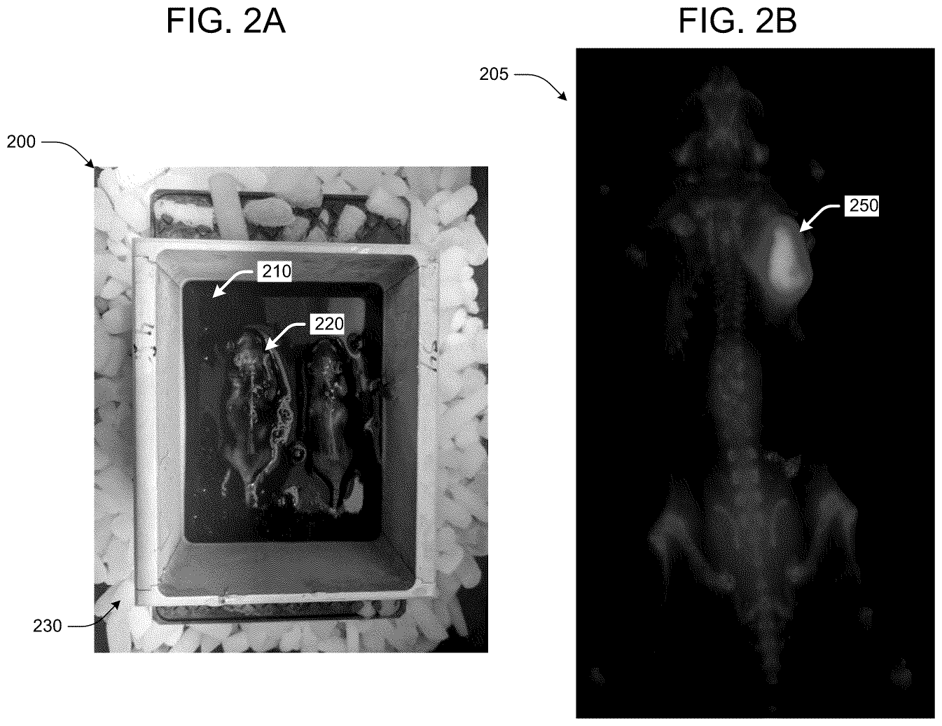

FIGS. 2A and 2B demonstrate the use of C45 carbon black in an embedding composition 210. C45 carbon black is a conductive carbon powder sometimes used as an additive in lithium-ion batteries. C45 carbon black may have a particle size of approximately 100-200 nm. In some implementations, a smaller or larger particle size may be used. In some cases, the particles used may have a range of sizes. FIG. 2A shows an experimental setup 200 including a mouse 220 embedded in an embedding composition 210 comprising OCT including 0.3% carbon by weight, similar to the first block 110 shown in FIG. 1. The mouse was prepared with a fluorogenic-activating protein (FAP) probe including a ZW800-1, a near infrared (NIR) fluorophore manufactured by Curadel, LLC of Natick, Massachusetts. The mouse was then immersed in the 0.3% carbon embedding composition 210 and cooled on ice 230 to form a solid block.

FIG. 2B shows an image 205 of the mouse prepared using the experimental setup 200. The image 205 was obtained using a Xerra imaging system manufactured by Emit Imaging, Inc. of Baltimore, Maryland. The image 205 reveals the FAP probe as shown by the bright area 250. Furthermore, the image 205 captures the FAP probe without edge brightening (e.g., a “glow” around the specimen) typical of imaging in clear OCT.

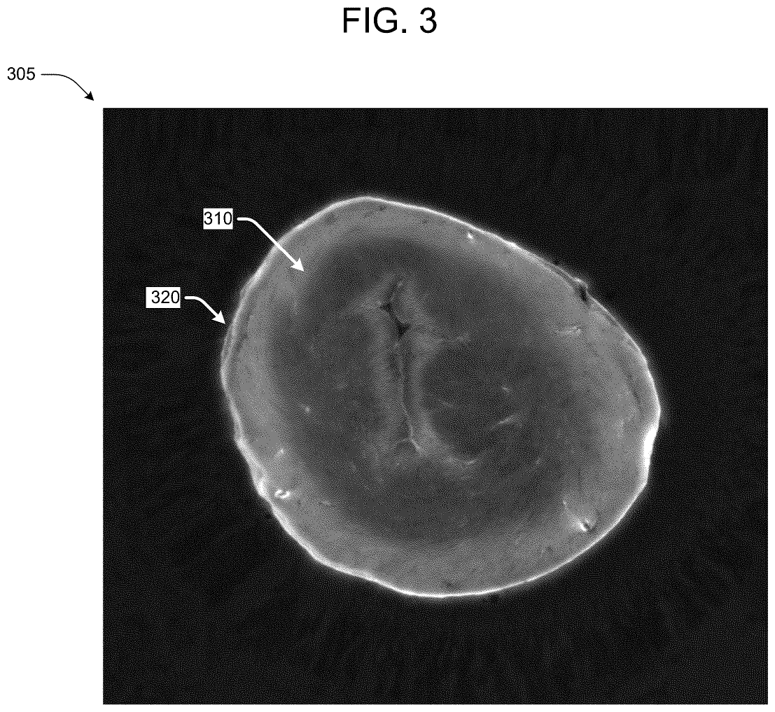

FIG. 3 is an image 305 showing autofluorescence of a porcine heart 310 embedded in an embedding composition 210 comprising OCT including 0.06% carbon by weight, similar to the second block 120 shown in FIG. 1. The autofluorescence was generated using excitation at 470 nm wavelength resulting in emission at 511 nm. The white ring 320 around the porcine hear represents the autofluorescence generated by the heart tissue.

FIGS. 2A, 2B, 3 show that compositions of OCT pigmented with carbon black can yield good images of fluorophore fluorescence and autofluorescence. In some implementations, the concentration of carbon particles in the embedding composition 210 may be between 0.005% and 0.5% by weight. In some implementations, the concentration of carbon particles in the embedding composition 210 may be between 0.06% and 0.3% by weight.

### Example 2. Preparation of a Light-Attenuating Embedding Composition Comprising OCT and India Ink

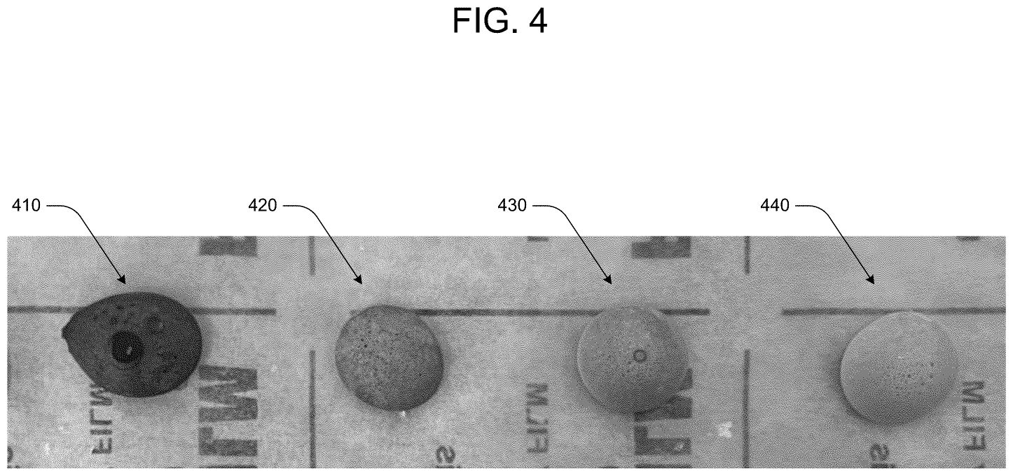

FIG. 4 shows blocks of OCT compositions prepared with different concentrations of India ink. India ink is a colloidal suspension of microfine carbon black in water. Some forms of India ink include a lacquer and/or binder agent such as gelatin or shellack to improve the durability of the dried ink. In some implementations, the India ink may include approximately 10% carbon particles, 89% water, and 1% binder. In some implementations, India ink may include different combinations and/or concentrations of ingredients. Embedding compositions formulated using India ink have benefits over those formed with C45 carbon. For example, India ink may be less messy to work with and pose less risk of contamination in a lab environment. Furthermore, India ink be less prone to clumping and/or settling; thus, the resulting composition may be easier to maintain as a homogeneous suspension over time.

The blocks of OCT compositions were formulated using volume-to-volume mixtures of OCT and Speedball Super Black India ink by Speedball Art Products of Statesville, North Carolina. The blocks are formed using various concentrations, by volume, of India ink in OCT: the first block 410 is a composition of 1% India ink by volume in the OCT, the second block 420 is 0.25% India ink, the third block 430 is 0.125% India ink, and the fourth block is 0.0625% India ink.

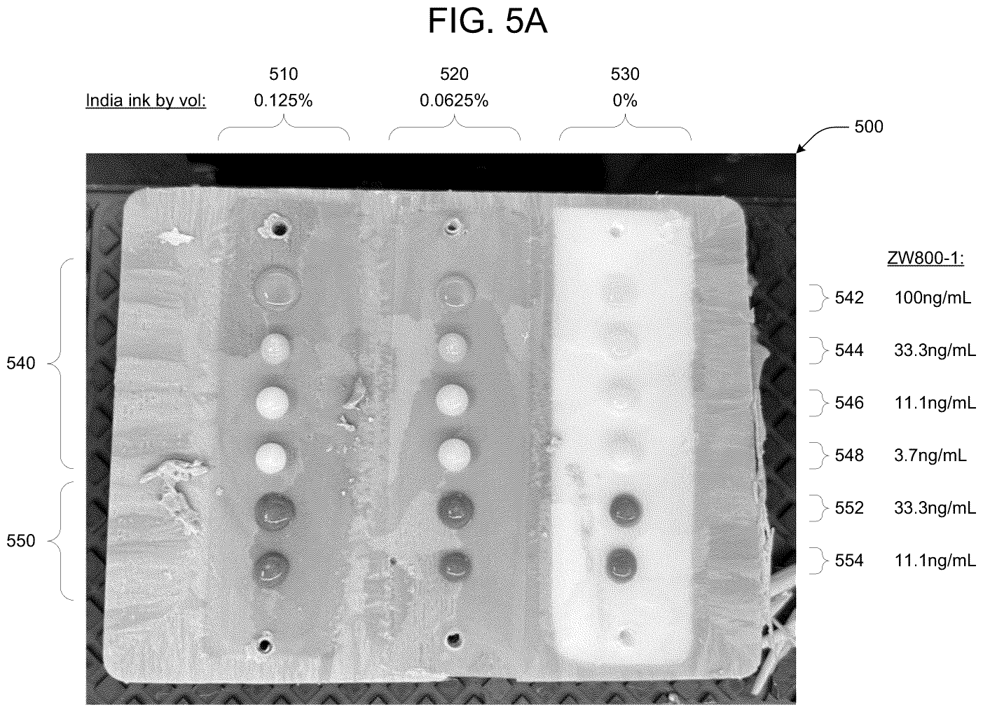

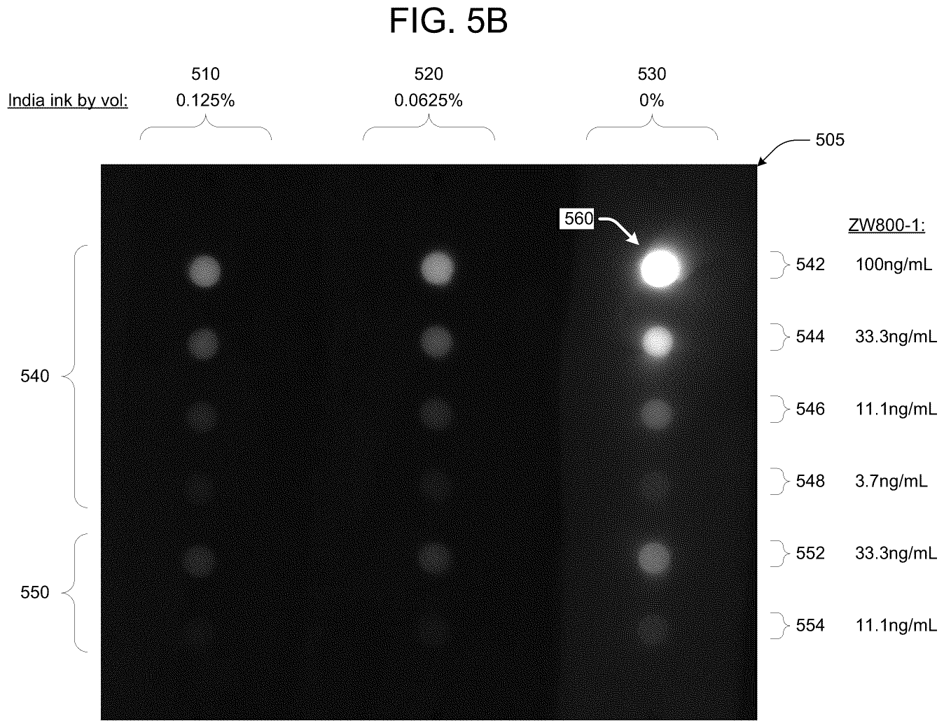

FIG. 5A shows an experimental setup 500 for testing various embedding compositions and fiducials. The embedding compositions include a first formulation of 0.125% India ink by volume in OCT (e.g., corresponding to the third block 430) in a first column 510, a second formulation of 520 of 0.0625% India ink (e.g., corresponding to the fourth block 440) in a second column, and a clear OCT (i.e., 0% India ink) in a third column. The embedding compositions were frozen in 125 ml trays and surfaced. Fiducial holes were drilled to create cylindrical cavities 5 mm in diameter and 15 mm deep.

The fiducials were filled with various materials. The first four rows 540 include OCT-based fiducials filled with mixtures of OCT (60%) having various concentrations of ZW800-1 in dimethylsulfoxide (DMSO). The first row 542 includes 100 ng/ml of ZW800-1, the second row 544 includes 33.3 ng/mL, the third row 546 includes 11.1 ng/ml, and the fourth row 548 includes 3.7 ng/mL ZW800-1. The bottom two rows 550 include tissue-based fiducials filled with bovine heart homogenate in phosphate buffered saline (PBS) at a concentration of 1.25 mL PBS/g tissue and a DMSO concentration of 3.33%. The fifth row 552 includes 33.3 ng/mL of ZW800-1 and the sixth row 554 includes 11.1 ng/mL.

TABLE 1
ng/mL to nM conversions for ZW800-1

| ZW800-1 in DMSO: | ZW800-1 in DMSO: |
|---|---|
| ng/mL | nM |
| 100 | 94.58 |
| 33.33 | 31.53 |
| 11.11 | 10.51 |
| 3.70 | 3.50 |
| 1.23 | 1.17 |
| 0.41 | 0.39 |

Table 1 shows ng/mL (nanograms per milliliter) to nM (nanomolar) conversions for solutions of ZW800-1 in DMSO. The ZW800-1 has a molecular weight of 1057.25 as trifluoroacetic salt. A stock solution of ZW800-1 may have a concentration of 1 μg/mL, or 945.8 nM. The ZW800-1 solution is diluted in a 3-fold series to yield the concentrations listed in Table 1 and used to generate the image 505 as shown in FIGS. 5B, 6A, 7A, and 8.

FIG. 5B shows an image 505 obtained of the experimental setup 500 shown in FIG. 5A and described above. The image 505 was obtained using a Xerra system with 780 nm wavelength excitation illumination at 25% of maximum power. Fluorescent emission at 840 nm wavelength was received over a 1,505 ms exposure. In general, rows 540 and 550 having higher concentrations of ZW800-1 were brighter. The fiducials in the third column 530 corresponding to the OCT without India ink (the clear OCT) are brighter than the corresponding fiducials in the first and second columns 510 and 520. The fiducial 560 corresponding to 100 ng/mL ZW800-1 in the OCT without India ink appears to saturate the detector of the imaging device, thus underestimating the amount of fluorescence in the fiducial 560. In addition, its diameter appears larger than those of the other fiducials despite the fiducial 560 itself having the same dimensions as the others.

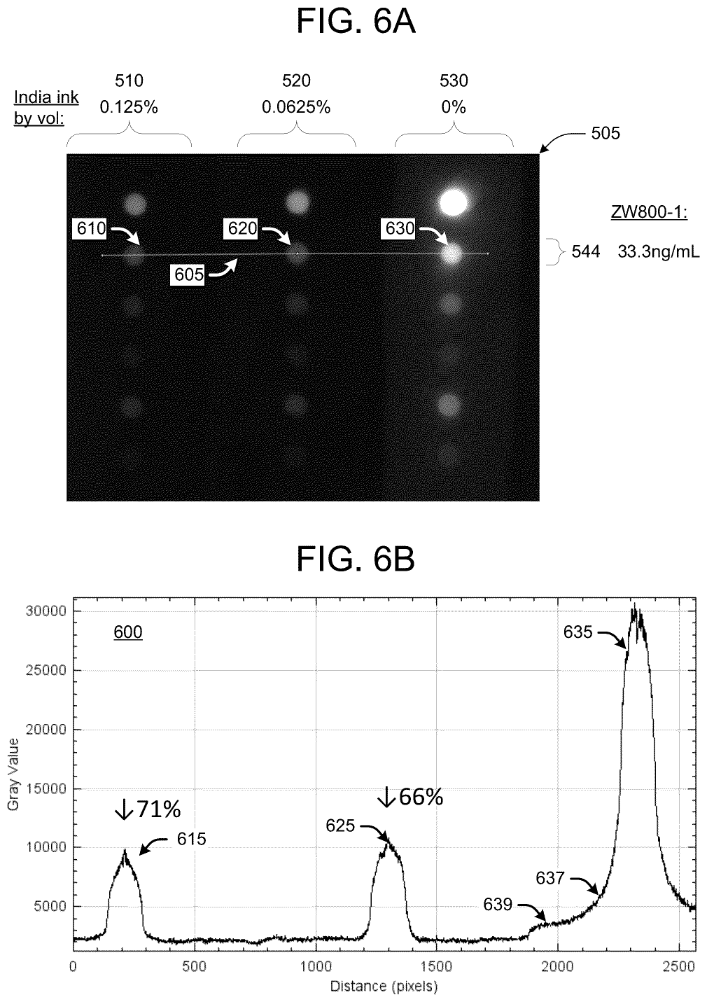

FIG. 6A shows a line 605 drawn across the second row 544 of fiducials indicating the source of data for the graph 600 of pixel intensities shown in FIG. 6B. The line 605 crosses fiducials 610, 620, and 630 in the first column 510, second column 520, and third column 530, respectively. The fiducials 610, 620, and 630 include 60% OCT, 3.33% DMSO, and 33.3 ng/ml ZW800-1.

FIG. 6B is a graph 600 showing pixel intensities of the image 505 shown in FIG. 6A across the line 605. The first fiducial 610 appears as the first peak 615, the second fiducial 620 as the second peak 625, and the third fiducial 630 as the third peak 635. The first peak 615, representing the first fiducial 610 in a composition of OCT having 0.125% India ink by volume, has pixel intensity reduced by 71% relative to the third peak 635 representing third fiducial 630 in the OCT without India ink. The second peak 625, representing the second fiducial 620 in a composition of OCT having 0.0625% India ink by volume, has pixel intensity reduced by 66% relative to the third peak 635. Nevertheless, the first and second peaks 615 and 625 are clearly discernable.

The third peak 635 representing the third fiducial 630 reveals distortions of the peak shape. For example, the third peak 635 exhibits peak broadening as shown by the slope 637 representing light received from outside of the third fiducial 630, possibly representing fluorescent emissions from the third fiducial 630 scattering in the clear OCT. In addition, the graph 600 of pixel intensities along the line 605 reveals that the pixel intensity near the third peak 635 does not return to the same noise floor as the first and second peaks 615 and 625; rather, the clear OCT seems to exhibit a raised noise floor 639 relative to the embedding compositions that include India ink.

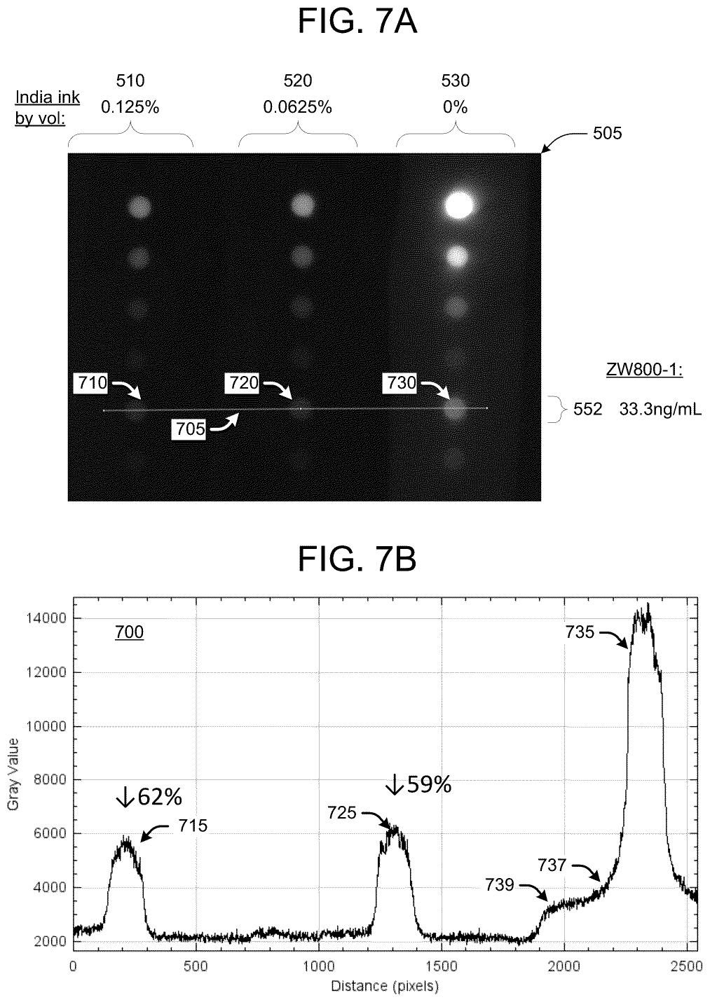

FIG. 7A shows a line 705 drawn across the fifth row 552 of fiducials indicating the source of data for the graph 700 of pixel intensities shown in FIG. 7B. The line 705 crosses fiducials 710, 720, and 730 in the first column 510, second column 520, and third column 530, respectively. The fiducials 710, 720, and 730 include bovine heart homogenate in phosphate buffered saline (PBS) at a concentration of 1.25 mL PBS/g tissue, a DMSO concentration of 3.33%, and a ZW800-1 concentration of 33.3 ng/mL.

FIG. 7B is a graph 700 showing pixel intensities of the image 505 shown in FIG. 7A across the line 705. The first fiducial 710 appears as the first peak 715, the second fiducial 720 as the second peak 725, and the third fiducial 730 as the third peak 735. The first peak 715, representing the first fiducial 710 in a composition of OCT having 0.125% India ink by volume, has pixel intensity reduced by 62% relative to the third peak 735 representing third fiducial 730 in the OCT without India ink. The second peak 725, representing the second fiducial 720 in a composition of OCT having 0.0625% India ink by volume, has pixel intensity reduced by 59% relative to the third peak 735. Nevertheless, the first and second peaks 715 and 725 are clearly discernable.

The third peak 735 representing the third fiducial 730 reveals distortions of the peak shape. For example, the third peak 735 exhibits peak broadening as shown by the slope 737 representing light received from outside of the third fiducial 730, possibly representing fluorescent emissions from the third fiducial 730 scattering in the clear OCT. Similar to the graph 600 of pixel intensities along the line 605, the graph 700 of pixel intensities along the line 705 reveals that the pixel intensity near the third peak 735 does not return to the same noise floor as the first and second peaks 715 and 725; rather, the clear OCT seems to exhibit a raised noise floor 739 relative to the embedding compositions that include India ink. Thus, an embedding composition 210 including India ink or other light-attenuating suspension may better distinguish legitimate fluorescent sources from scattering artifacts in non-fluorescing material as well as more accurately and precisely represent boundaries between the two (e.g., to determine whether a signal originates within a specimen or not).

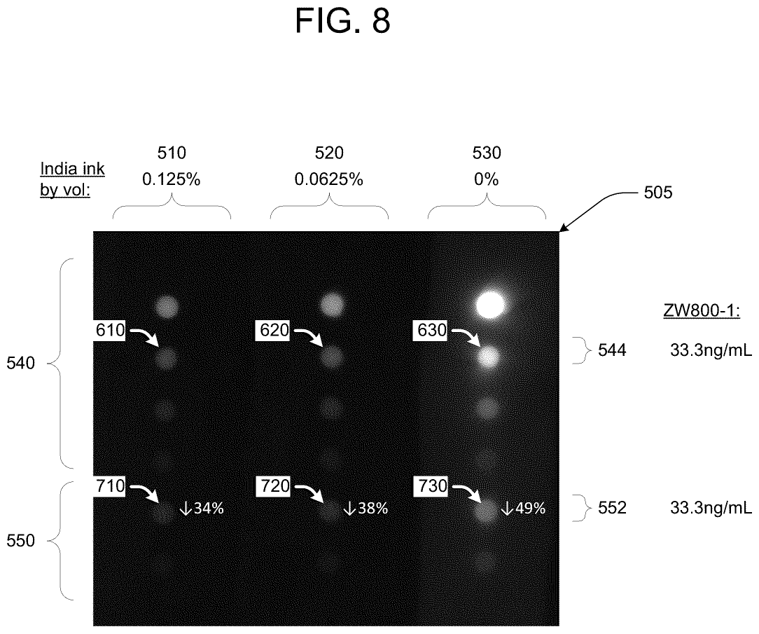

FIG. 8 shows a comparison of signal attenuation of fluorescence emitted from the OCT fiducials 610, 620, and 630 in the second row 544 and the tissue (bovine heart homogenate) fiducials 710, 720, and 730 in the fifth row 552 of the image 505. All six fiducials 610, 620, 630, 710, 720, and 730 include 33.3 ng/mL ZW800-1 fluorophore. The tissue fiducials 710, 720, and 730 exhibited reduced fluorescence relative to the OCT fiducials 610, 620, and 630 in the same embedding composition. The first tissue fiducial 710 had a 34% lower pixel intensity versus the first OCT fiducial 610, the second tissue fiducial 720 had a 38% lower pixel intensity versus the second OCT fiducial 620, and the third tissue fiducial 730 had a 49% lower pixel intensity versus the third OCT fiducial 630. The higher attenuation from the fiducial 630 to the fiducial 730 (e.g., relative to the attenuation from fiducial 620 to the fiducial 720 and from the fiducial 610 to the fiducial 710) may indicate that the apparent pixel intensity of the fiducial 630 has been exaggerated or amplified due to its proximity to the clear OCT.

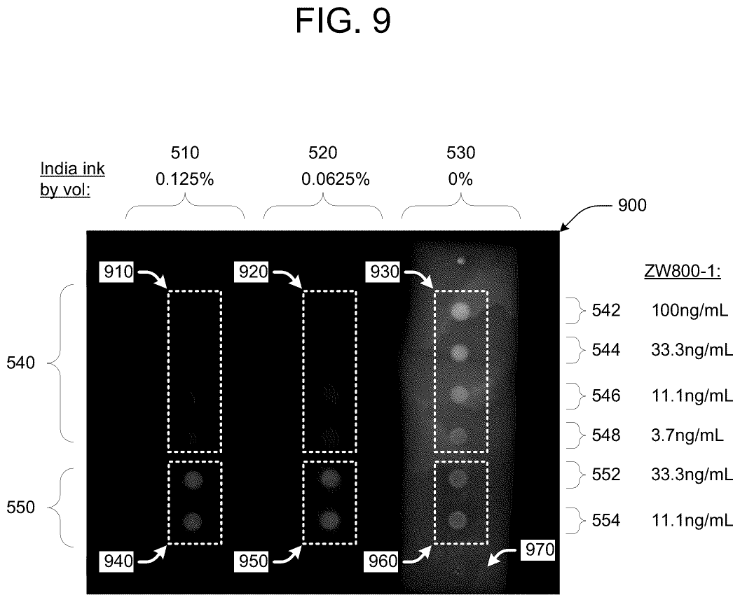

FIG. 9 shows an image 900 of autofluorescence in the embedding compositions and fiducials of Example 2. The autofluorescence was generated using excitation at 470 nm wavelength resulting in emission at 511 nm. The image was taken using a Xerra system with the 470 nm laser at 25% power.

While animal tissue would be expected to exhibit autofluorescence, the ZW800-1 fluorophore and OCT composition would not. The image 900 shows the bovine heart homogenate in the tissue fiducials 940, 950, and 960 exhibit autofluorescence as expected. The image 900 also shows that the OCT fiducials 910 and 920 in the India ink embedding compositions exhibit little or no autofluorescence. The image 900 shows, however, that the OCT in the OCT-based fiducials 930 in the clear OCT embedding 970 appears to exhibit autofluorescence. Furthermore, the clear OCT embedding 970 also appears to exhibit autofluorescence. The apparent autofluorescence may be actual autofluorescence or an artifact of some other phenomena such as light reflecting from the OCT and/or off-band light not blocked by the filter(s) of the imaging system.

In any case, the image 900 shows that the light-attenuating embedding compositions may mitigate or eliminate autofluorescence or artifacts in addition to mitigating or eliminating the image distortions caused by a clear embedding medium. Investigation of the autofluorescence phenomenon is discussed below in Example 5. In some implementations, the concentration of India ink in the embedding composition may be between 0.01% and 1% by volume. In some implementations, the concentration of India ink in the embedding composition may be between 0.05% and 0.25% by volume. In some implementations, the concentration of India ink in the embedding composition may be between 0.0625% and 0.125% by volume.

### Example 3. Further Characterization of Light-Attenuating Embedding Compositions Comprising OCT and India Ink Using OCT-Based Fiducials

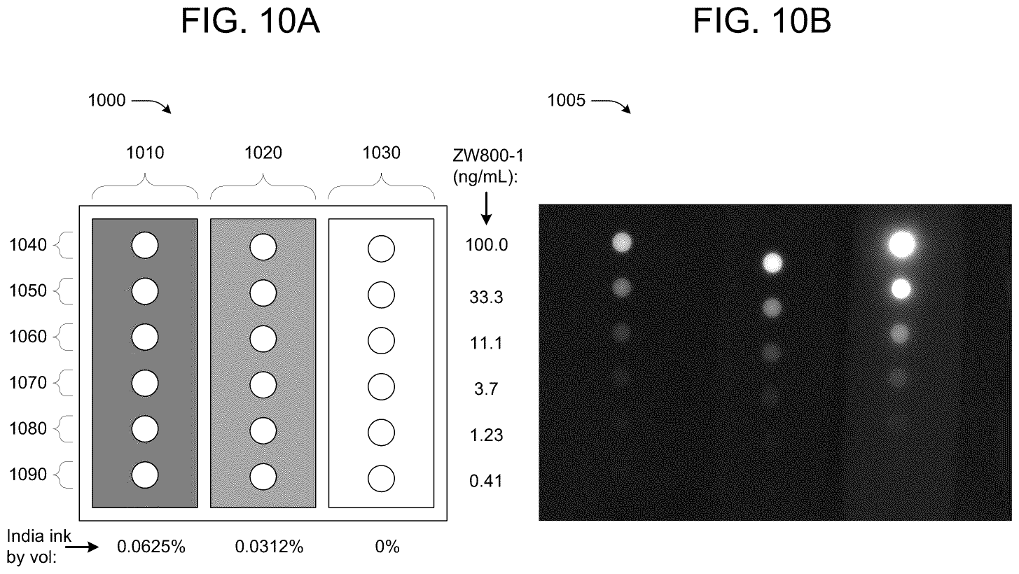

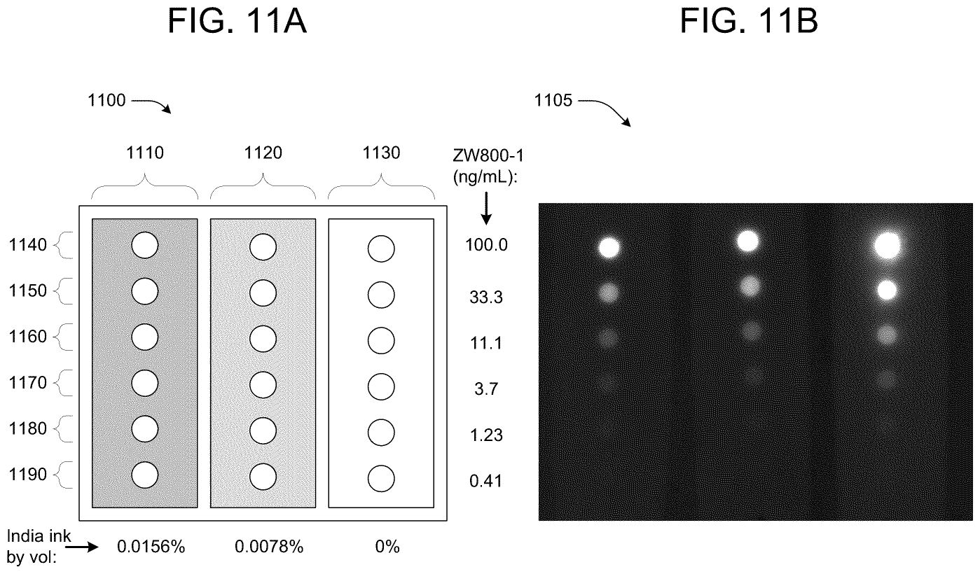

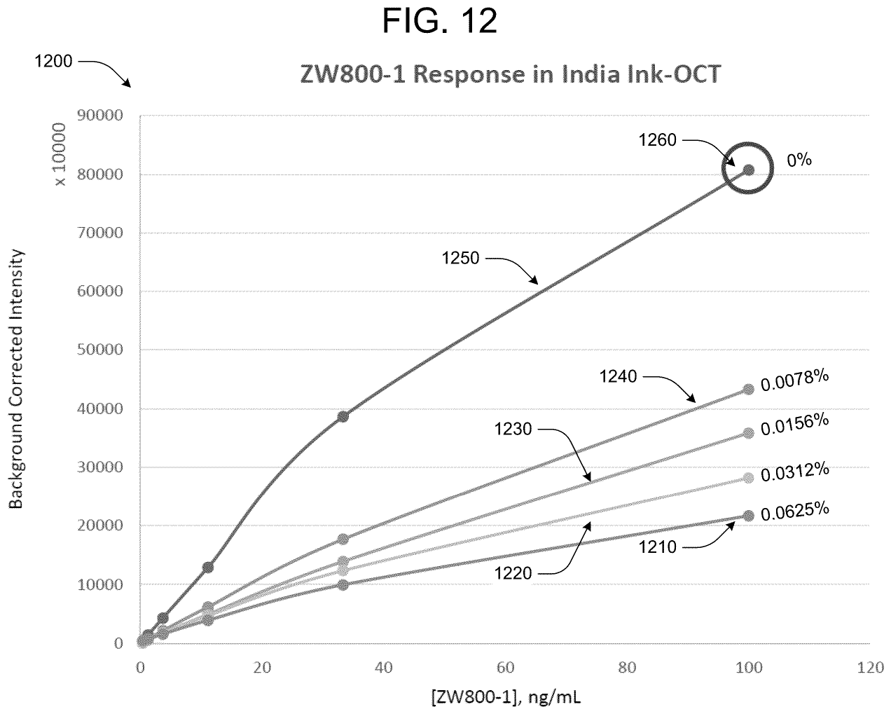

FIG. 10A is a conceptual drawing showing an experimental setup 1000 used for characterizing light-attenuating embedding compositions comprising OCT and India ink using OCT-based fiducials. FIG. 10B shows an image 1005 obtained using the experimental setup 1000. FIGS. 11A and 11B, described below, represent a similar experiment performed with embedding compositions having different concentrations of India ink. Pixel intensities from the resulting images 1005 and 1105 were used to generate the graph 1200 shown in FIG. 12.

The experimental setup 1000 includes three different embedding compositions organized into columns. A first column 1010 includes an embedding composition comprising OCT with 0.0625% India ink by volume. A second column 1020 includes an embedding composition comprising OCT with 0.0312% India ink by volume. A third column 1030 includes a clear OCT without India ink.

The experimental setup 1000 includes six different fiducial mixtures organized into rows. The fiducials are comprised of OCT and ZW800-1 following a three-fold dilution from row to row. A first row 1040 includes OCT with 100 ng/mL ZW800-1. A second row 1050 includes OCT with 33.3 ng/mL ZW800-1. A third row 1060 includes OCT with 11.1 ng/mL ZW800-1. A fourth row 1070 includes OCT with 3.7 ng/mL ZW800-1. A fifth row 1080 includes OCT with 1.23 ng/mL ZW800-1. A sixth row 1090 includes OCT with 0.41 ng/mL ZW800-1.

FIG. 11A is a conceptual drawing showing an experimental setup 1100 used for characterizing light-attenuating embedding compositions comprising OCT and India ink using OCT-based fiducials. FIG. 11B shows an image 1105 obtained using the experimental setup 1100. Similar to the experimental setup 1000, the experimental setup 1100 includes a first column 1110 having an embedding composition comprising OCT with 0.0156% India ink by volume, a second column 1120 having an embedding composition comprising OCT with 0.0078% India ink by volume, and a third column 1130 having a clear OCT without India ink. The experimental setup 1100 includes six different fiducial mixtures comprised of OCT and ZW800-1 organized into rows. A first row 1140 includes 100 ng/mL ZW800-1, a second row 1150 includes 33.3 ng/mL ZW800-1, a third row 1160 includes 11.1 ng/mL ZW800-1, a fourth row 1170 includes 3.7 ng/mL ZW800-1, a fifth row 1180 includes 1.23 ng/mL ZW800-1, and a sixth row 1190 includes 0.41 ng/mL ZW800-1.

FIG. 12 shows a graph 1200 illustrating pixel intensities obtained from the images 1005 and 1105. The graph 1200 shows the linearity of pixel intensity (corrected for background) for the different fiducials in the different embedding compositions. Each line corresponds to a particular embedding composition or compound: a first line 1210 corresponds to an embedding compound having 0.0625% India ink by volume, a second line 1220 corresponds to 0.0312%, a third line 1230 corresponds to 0.0156%, a fourth line 1240 corresponds to 0.0078%, and a fifth line 1250 corresponds to clear OCT (i.e., 0% India ink).

Similar to the fiducial 560 in the clear OCT shown in the image 505 (e.g., also having 100 ng/mL ZW800-1), the fifth line 1250 shows a pronounced non-linearity of pixel intensities for fiducials in the clear OCT (i.e., 0% India ink). In particular, the point 1260 corresponding to the 100 ng/mL ZW800-1 fiducial in the clear OCT has a lower pixel intensity than would be expected based on continuing the trend of pixel intensities for the other fiducials in the clear OCT, indicating saturation of the detector.

The first four lines 1210 through 1240 show reasonable linearity with perhaps a slight downward curve, which may be attributable to a tendency of OCT to bubble in pipettes, making it difficult to dilute in a perfect three-fold manner when preparing embedding compositions by volume. Embedding compositions formulated by weight of OCT rather than volume may improve the linearity of the pixel intensity measurements. In any case, the results show good sensitivity down to nanomolar concentrations of the ZW800-1 fluorophores despite the attenuation of signal in the embedding compositions that include India ink.

### Example 4. Characterizing Tissue-Based Fiducials and Identifying Biologically Relevant Fluorophore Concentrations

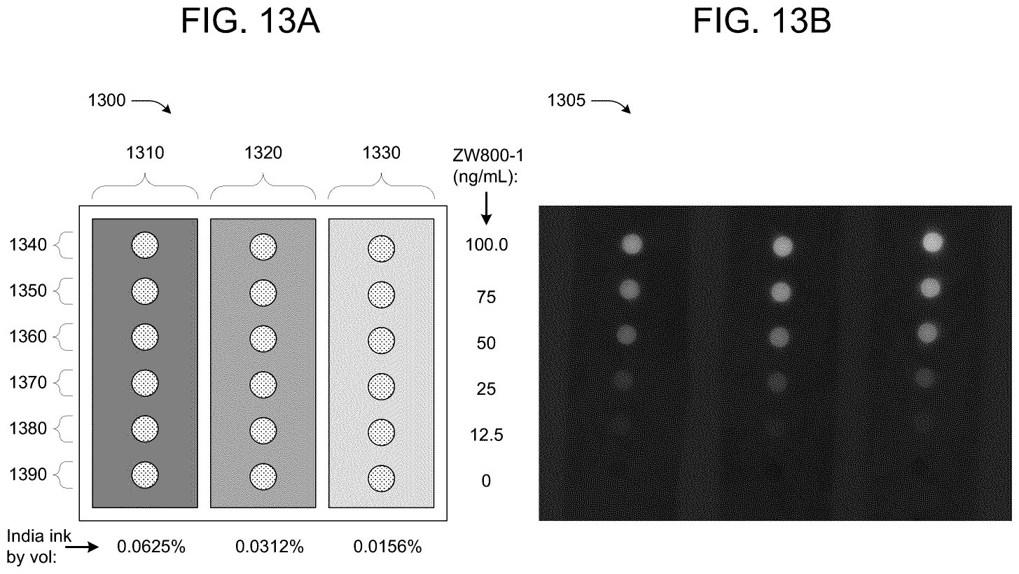

FIG. 13A is a conceptual drawing showing an experimental setup 1300 used for characterizing tissue-based fiducials and identifying biologically relevant fluorophore concentrations. The purpose of the study was to determine which types of fiducials are suitable for system characterizations, which embedding compositions simulate/approximate behavior of surrounding animal tissues, and which concentrations of ZW800-1 may be biologically relevant.

The experimental setup 1300 includes three different embedding compositions organized into columns: a first column 1310 having an embedding composition comprising OCT with 0.0625% India ink by volume, a second column 1320 having 0.0312% India ink by volume, and a third column 1330 having 0.0156% India ink by volume.

The experimental setup 1300 includes six different fiducial mixtures organized into rows. The fiducials are comprised of bovine heart homogenate in PBS at a concentration of 1.25 mL PBS/g tissue and a DMSO concentration of 3.33% and ZW800-1 in the following concentrations: a first row 1340 having 100 ng/mL ZW800-1, a second row 1350 having 75 ng/mL ZW800-1, a third row 1360 having 50 ng/mL ZW800-1, a fourth row 1370 having 25 ng/mL ZW800-1, a fifth row 1380 having 12.5 ng/mL ZW800-1, and a sixth row 1390 having 0 ng/mL ZW800-1.

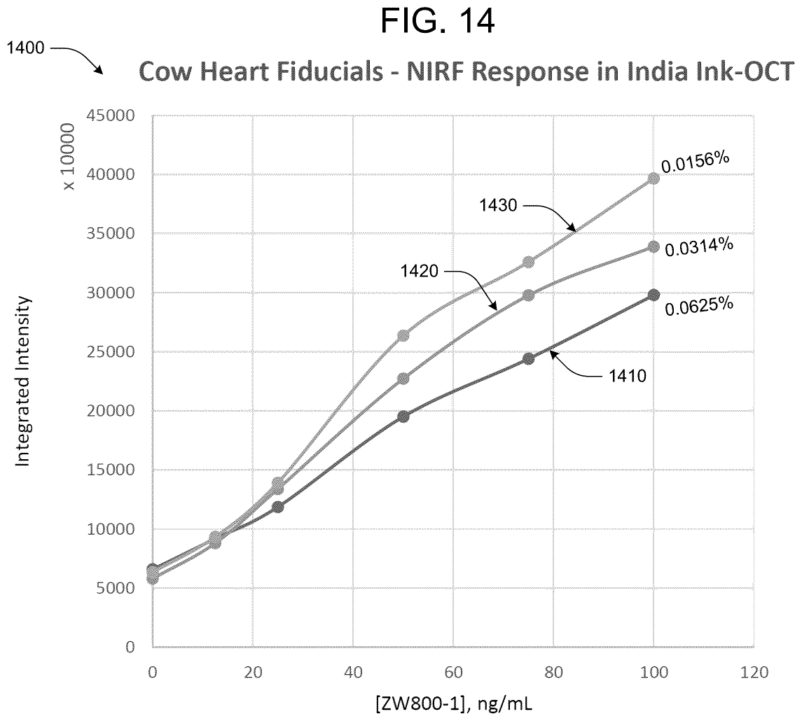

FIG. 13B shows an image 1305 obtained using the experimental setup 1300, a near infrared (NIR) 780 nm wavelength excitation illumination resulting in an 840 nm emission wavelength. The image 1305 was obtained using a Xerra system with a 2,500 ms exposure time. Pixel intensities from the resulting image 1305 were used to generate the graph 1400 shown in FIG. 14.

FIG. 14 shows a graph 1400 illustrating integrated pixel intensities obtained from the image 1305. The graph 1400 shows the linearity of pixel intensity for the different fiducials in the different embedding compositions. Each line corresponds to a particular embedding composition or compound: a first line 1410 corresponds to an embedding compound having 0.0625% India ink by volume, a second line 1420 corresponds to 0.0314%, and a third line 1430 corresponds to 0.0156%.

The lines 1410 through 1430 show reasonable linearity in each embedding composition throughout the range of fluorophore concentrations. In general, a higher concentration of India ink in the embedding composition resulted in more attenuation of the signal.

### Example 5. Investigation of Autofluorescence in OCT Embedding Compound and Fiducials

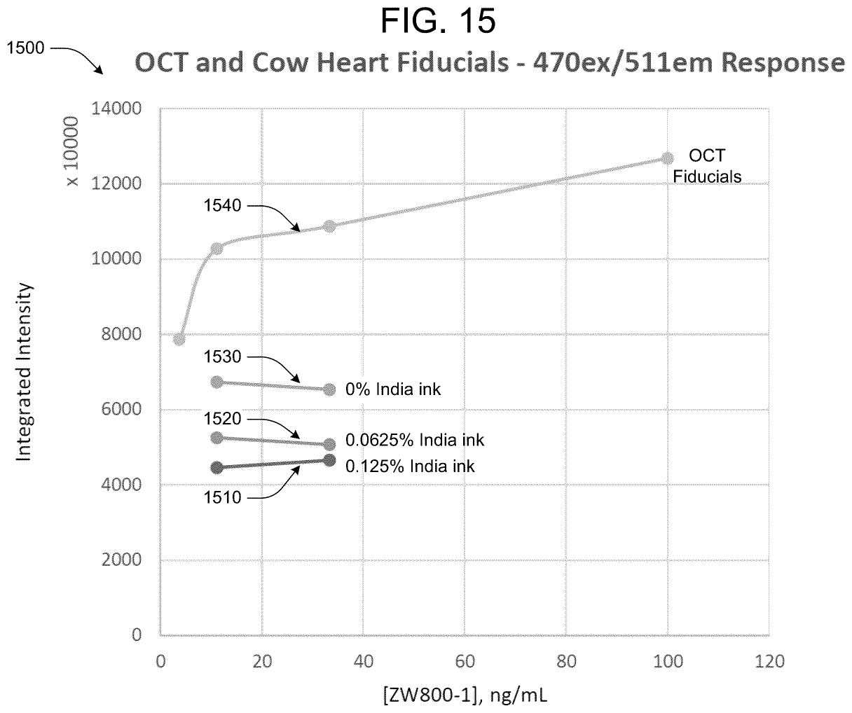

FIG. 15 shows a graph 1500 of integrated pixel intensities from the image 900 shown in FIG. 9 showing autofluorescence in the experimental setup 500 shown in FIG. 5B. The autofluorescence was generated using excitation at 470 nm wavelength resulting in emission at 511 nm. The image was taken using a Xerra system with the 470 nm laser at 25% power. The integrated pixel intensities were graphed to investigate the autofluorescence exhibited in the image 900.

The first three lines 1510 through 1530 represent the tissue-based fiducials in the bottom two rows 550. The first line 1510 represents the tissue fiducials having ZW800-1 concentrations of 11.1 ng/mL and 33.3 ng/mL, respectively, in an embedding composition having 0.125% India ink by volume. The second line 1520 represents similar fiducials in an embedding composition having 0.125% India ink by volume. The third line 1530 represents similar fiducials in clear OCT (i.e., having 0% India ink). A fourth line 1540 represents the OCT fiducials in the clear OCT and having ZW800-1 concentrations of 3.7 ng/ml, 11.1 ng/ml, 33.3 ng/ml, and 100 ng/mL, respectively.

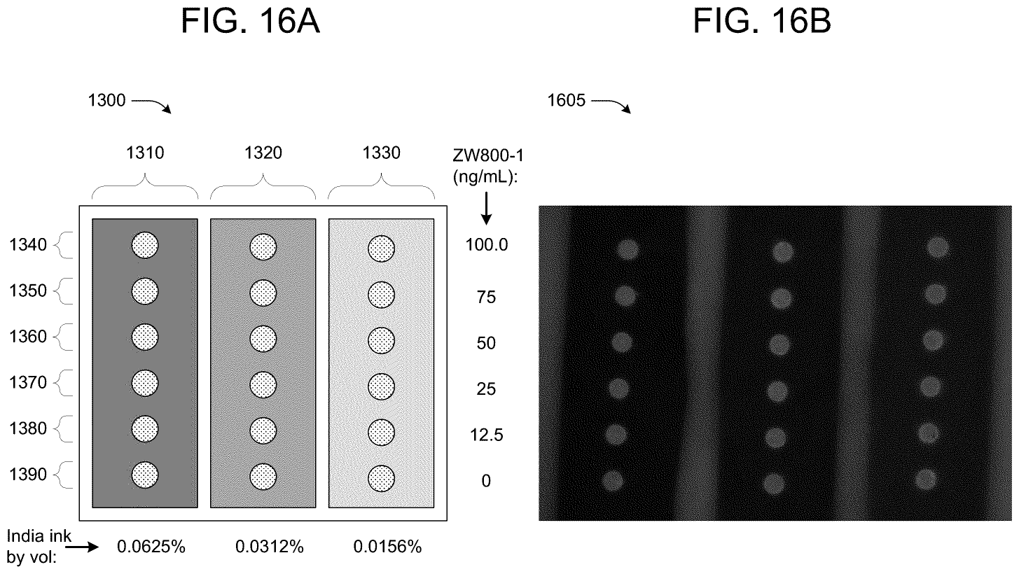

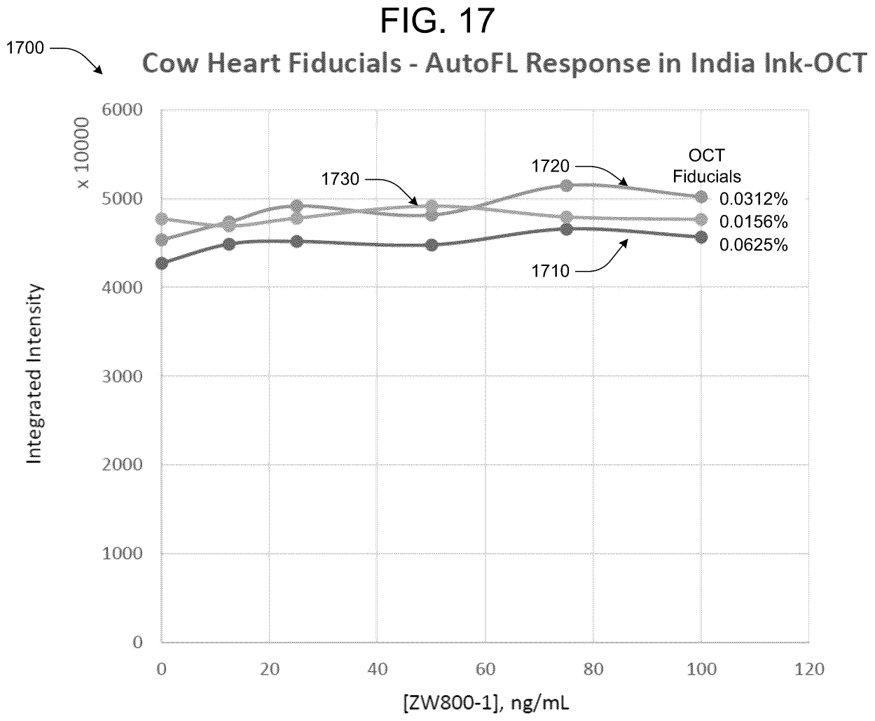

FIG. 16A is a conceptual drawing showing the experimental setup 1300 used for characterizing tissue-based fiducials. FIG. 16B shows an image 1605 generated based on autofluorescence in the experimental setup 1300. The autofluorescence was generated using excitation at 470 nm wavelength resulting in emission at 511 nm. The image was taken using a Xerra system with the 470 nm laser at 25% power and a 2,500 ms exposure time. Pixel intensities from the resulting image 1605 were used to generate the graph 1700 shown in FIG. 17.

FIG. 17 shows a graph 1700 of integrated pixel intensities from the image 1605 showing autofluorescence in the experimental setup 1300. The integrated pixel intensities were graphed to investigate the autofluorescence exhibited in the image 1605. The first line 1710 represents tissue-based fiducials in an embedding composition comprising OCT with 0.0625% India ink by volume, the second line 1720 represents the fiducials in an embedding composition with 0.0312% India ink by volume, and the third line 1730 represents the fiducials in an embedding composition with 0.0156% India ink by volume.

Unless otherwise defined, scientific and technical terms used herein shall have the meanings that are commonly understood by those of ordinary skill in the art. Further, unless otherwise required by context, singular terms shall include pluralities, and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

As used herein, the term “about,” means approximately. When the term “about” is used in conjunction with a numerical range, it modifies that range by extending the boundaries above and below the numerical values set forth. Illustratively, the use of the term “about” indicates that values slightly outside the cited values (i.e., plus or minus 0.1% to 10%), which are also effective and safe are included in the value. Numerical ranges recited herein by endpoints include all numbers and fractions subsumed within that range (e.g., 1 to 5 includes 1, 1.5, 2, 2.75, 3, 3.90, 4, and 5).

As used herein, the terms “comprising” (and any form of comprising, such as “comprise,” “comprises,” and “comprised”), “having” (and any form of having, such as “have” and “has”), “including” (and any form of including, such as “includes” and “include”), and “containing” (and any form of containing, such as “contains” and “contain”) are inclusive or open-ended and do not exclude additional, un-recited elements or method steps. Additionally, a term that is used in conjunction with the term “comprising” is also understood to be able to be used in conjunction with the term “consisting of” or “consisting essentially of.”

Method steps described in this disclosure can be performed in any order unless otherwise indicated or otherwise clearly contradicted by context.

For the avoidance of doubt, insofar as is practicable any embodiment of a given aspect of the present disclosure may occur in combination with any other embodiment of the same aspect of the present disclosure. In addition, insofar as is practicable it is to be understood that any preferred or optional embodiment of any aspect of the present disclosure should also be considered as a preferred or optional embodiment of any other aspect of the present disclosure.

1. An embedding composition for preparing a specimen for sectioning, the embedding composition comprising:
a continuous phase including at least one of optimal cutting temperature compound (OCT), paraffin, water-based glycol, epoxy, gelatin, celloidin, tris-buffered saline (TBS), Cryogen, or resin; and
a dispersed phase suspended in the continuous phase, the dispersed phase including at least one of carbon particles, India ink, carbonates, talcum powder, barium sulfate, or dried red blood cells.

2. The embedding composition of claim 1, wherein the continuous phase includes OCT.

3. The embedding composition of claim 1, wherein the dispersed phase includes carbon particles.

4. The embedding composition of claim 3, wherein the carbon particles are C45 carbon particles.

5. The embedding composition of claim 3, wherein a concentration range of carbon particles corresponds to 0.005% to 0.50% of the embedding composition by weight.

6. The embedding composition of claim 5, wherein the concentration range of carbon particles corresponds to 0.06% to 0.30% of the embedding composition by weight.

7. The embedding composition of claim 1, wherein the dispersed phase is India ink.

8. The embedding composition of claim 7, wherein a concentration range of India ink corresponds to 0.01% to 1.0% of the embedding composition by volume.

9. The embedding composition of claim 8, wherein the concentration range of India ink corresponds to 0.05% to 0.25% of the embedding composition by volume.

10. The embedding composition of claim 8, wherein the concentration range of India ink corresponds to 0.0625% to 0.125% of the embedding composition by volume.

11. An embedding composition for preparing a specimen for sectioning, the embedding composition comprising:
a continuous phase of optimal cutting temperature compound (OCT); and
a dispersed phase suspended in the continuous phase, the dispersed phase including India ink having a concentration corresponding to 0.001%-1.0% of the embedding composition by volume.

12. The embedding composition of claim 11, wherein a concentration range of India ink corresponds to 0.01% to 1% of the embedding composition by volume.

13. The embedding composition of claim 12, wherein the concentration range of India ink corresponds to 0.0625% to 0.125% of the embedding composition by volume.

14. A method of making an embedding composition for preparing a specimen for sectioning, the method comprising:
obtaining a continuous phase including at least one of OCT, paraffin, water-based glycol, epoxy, gelatin, celloidin, tris-buffered saline (TBS), Cryogen, or resin;
obtaining a dispersed phase including at least one of carbon particles, India ink, carbonates, talcum powder, barium sulfate, or dried red blood cells; and
combining the continuous phase and the dispersed phase such that the dispersed phase is suspended substantially uniformly throughout the continuous phase.

15. The method of claim 14, wherein the continuous phase includes OCT.

16. The method of claim 14, wherein the dispersed phase includes carbon particles.

17. The method of claim 14, wherein a concentration range of carbon particles corresponds to 0.06% to 0.3% of the embedding composition by weight.

18. The method of claim 14, wherein the dispersed phase is India ink.

19. The method of claim 18, wherein a concentration range of India ink corresponds to 0.01% to 1% of the embedding composition by volume.

20. The method of claim 19, wherein the concentration range of India ink corresponds to 0.0625% to 0.125% of the embedding composition by volume.
